(19) United States
(12) Patent Application Publication
(10) Pub. No.: US 2015/0298473 A1
(43) Pub. Date: Oct. 22, 2015

(54) RECORDING APPARATUS

(71) Applicant: SEIKO EPSON CORPORATION, Tokyo (JP)

(72) Inventors: Osamu HARA, Matsumoto-shi (JP); Tsuneyuki SASAKI, Matsumoto-shi (JP)

(21) Appl. No.: 14/685,851

(22) Filed: Apr. 14, 2015

(30) Foreign Application Priority Data
Apr. 17, 2014 (JP) 2014-085311

(51) Int. Cl. B41J 25/308

(52) U.S. Cl. CPC B41J 25/308

(57) ABSTRACT

A recording apparatus includes a transport section that transports a recording medium, a movement section that includes a recording head capable of ejecting ink onto the recording medium, and that is capable of moving along a cross direction intersecting with a transport direction of the recording medium, and a gap detection section that is provided to the movement section and detects a gap between the recording head and the recording medium. The gap detection section includes plural light emitting devices capable of radiating light toward different positions on the recording medium, and a light receiving device capable of receiving reflected light that was radiated from the plural light emitting devices.

### BACKGROUND

1. Technical Field

The present invention relates to a recording apparatus.

2. Related Art

Hitherto, recording apparatuses have been used that record by transporting a recording medium and ejecting ink from a recording head onto the transported recording medium. With thus configured recording apparatuses, sometimes wrinkles, lifting, and the like occur in the transported recording medium, such that the quality of recorded images deteriorates due to change in the gap between the recording head and the recording medium (called the PG).

In order to address this, technique is described, such as that of the recording apparatuses described in, for example, JP-A-10-217444, JP-A-2005-41067, and JP-A-2010-173148, in which the PG is detected, and the above-described problems are suppressed.

Hitherto, detection of the PG in recording apparatuses has been performed by a detection section configured by a single light emitting device and a single light receiving device.

However, the requirements for image quality in recording apparatuses have become more exacting recently.

There is accordingly a desire to suppress deterioration in quality of recorded images to a greater extent than in recording apparatuses hitherto.

### SUMMARY

An advantage of some aspects of the invention is that deterioration in the quality of recorded images due to change in the gap between the recording head and the recording medium is suppressed.

A recording apparatus of an aspect of the invention includes a transport section that transports a recording medium, a movement section that includes a recording head capable of ejecting ink onto the recording medium, and that is capable of moving along a cross direction intersecting with a transport direction of the recording medium, and a gap detection section that is provided to the movement section and detects a gap between the recording head and the recording medium. The gap detection section includes plural light emitting devices capable of radiating light toward different positions on the recording medium, and a light receiving device capable of receiving reflected light that was radiated from the plural light emitting devices.

The recording apparatus of the aspect further includes a controller that controls at least one of ink ejection timing and ink ejection speed from the recording head based on a detection result detected by the gap detection section.

In the above recording apparatus, the controller estimates the gap from received light intensity of the reflected light detected by the gap detection section.

In the recording apparatus of the aspect, the gap detection section is provided upstream of the recording head in the transport direction.

In the recording apparatus of the aspect, the gap detection section is provided upstream of the recording head in a movement direction of the movement section during recording.

In the above recording apparatus, the gap detection section is provided at a position in a row with the recording head in the cross direction.

In the recording apparatus of the aspect, wavelengths of light radiated from the plural light emitting devices are different from each other.

According to the invention, deterioration in the quality of recorded images due to change in a gap between a recording head and a recording medium is suppressed.

### BRIEF DESCRIPTION OF THE DRAWINGS

The invention will be described with reference to the accompanying drawings, wherein like numbers reference like elements.

FIG. 1 is a schematic side view illustrating a recording apparatus according to a first embodiment of the invention.

FIG. 2 is a schematic plan view illustrating the recording apparatus according to the first embodiment of the invention.

FIG. 3 is a schematic front view illustrating relevant portions of the recording apparatus according to the first embodiment of the invention.

FIG. 4 is a graph illustrating an example of measurements of a PG by the recording apparatus according to the first embodiment of the invention.

FIG. 5 is a schematic front view illustrating relevant portions of the recording apparatus according to the first embodiment of the invention.

FIG. 6 is a block diagram of the recording apparatus according to the first embodiment of the invention.

FIG. 7 is a schematic side view illustrating a recording apparatus according to a second embodiment of the invention.

FIG. 8 is a schematic side view illustrating a recording apparatus according to a third embodiment of the invention.

### DESCRIPTION OF EXEMPLARY EMBODIMENTS

Detailed explanation follows regarding a recording apparatus according to an embodiment of the invention, with reference to the appended drawings.

### First Embodiment

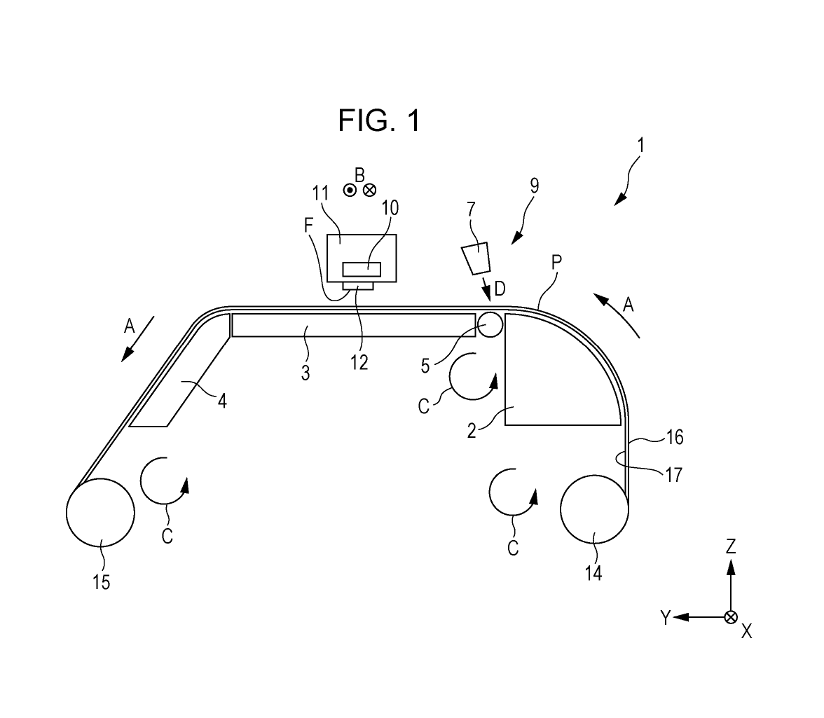

### FIG. 1 to FIG. 6

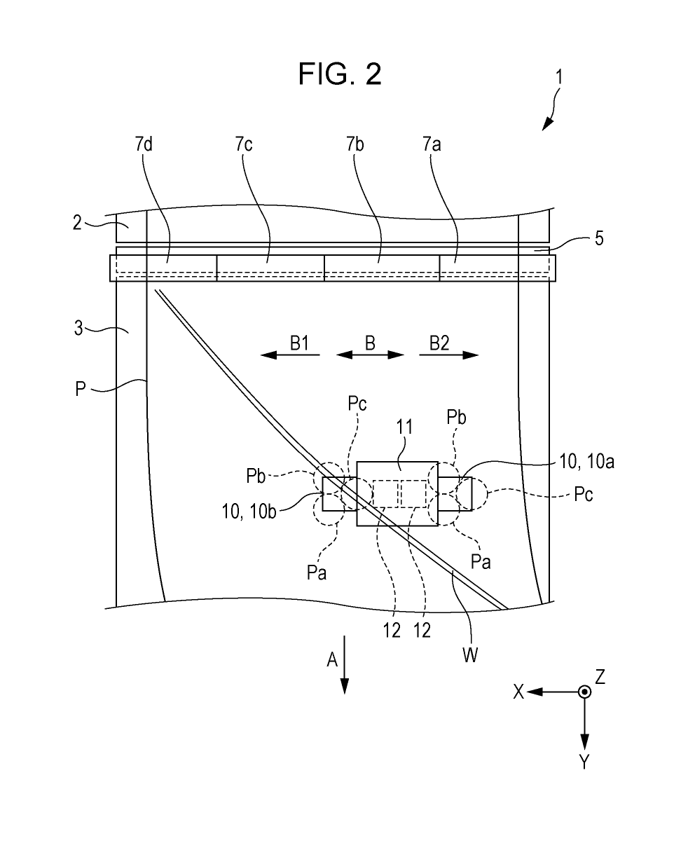

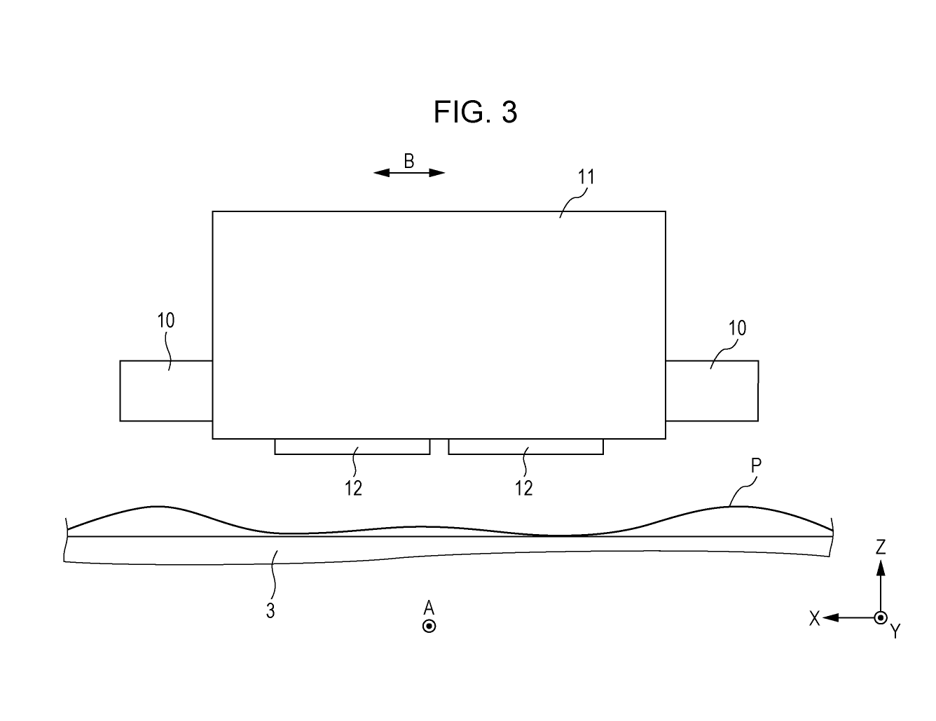

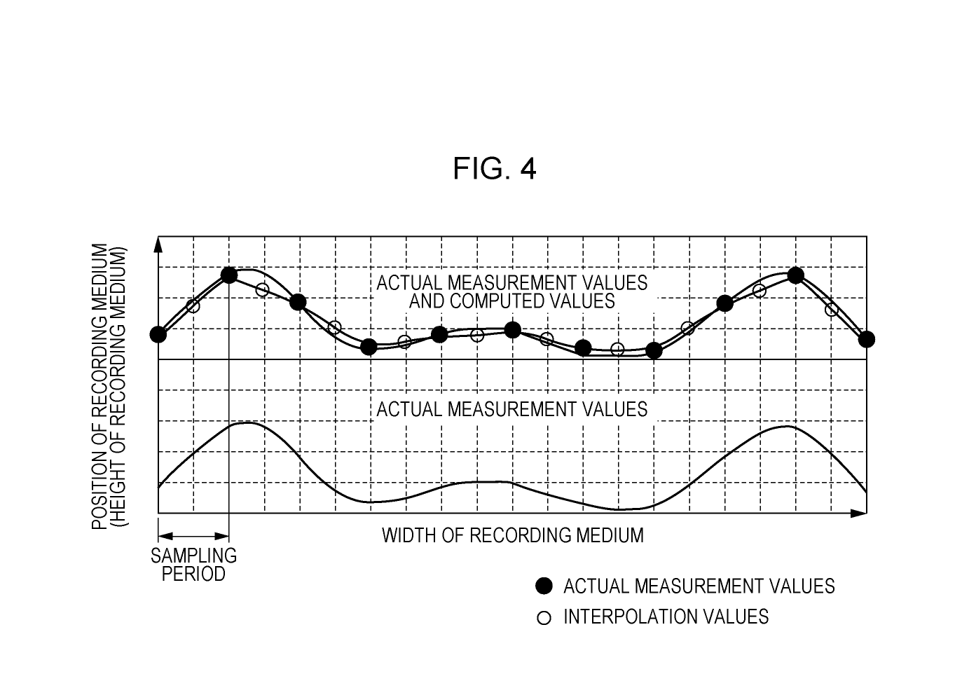

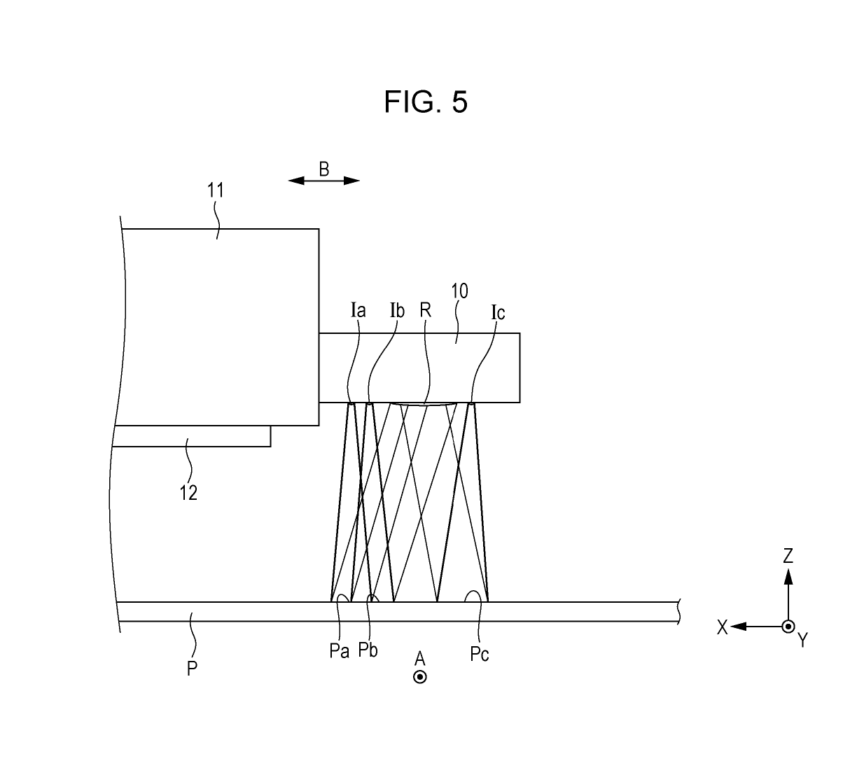

FIG. 1 is a schematic side view illustrating a recording apparatus 1 according to a first embodiment of the invention. FIG. 2 is a schematic plan view illustrating the recording apparatus 1 according to the first embodiment of the invention. FIG. 3 and FIG. 5 are schematic front views illustrating relevant portions of the recording apparatus 1 according to the first embodiment of the invention. FIG. 4 is a graph illustrating an example of measurements of PG by the recording apparatus 1 according to the first embodiment of the invention.

As illustrated in FIG. 1, the recording apparatus 1 of the present embodiment transports a recording medium P in a transport direction A, from a feeder 14 that feeds out the recording medium P, through a platen 2, a platen 3, and a platen 4 serving as a support section for the recording medium P, to a winding section 15 for the recording medium P. That is, there is a transport path of the recording medium P in the recording apparatus 1 from the feeder 14 to the winding section 15, and there is a support section for the recording medium P that includes the platen 2, the platen 3, and the platen 4 provided on the transport path.

The feeder 14 rotates in a rotation direction C to feed out the recording medium P, and the winding section 15 rotates in the rotation direction C to wind the recording medium P.

The recording apparatus 1 of the present embodiment is configured to enable recording on the recording medium P in the form of a roll. However, there is no limitation thereto, and configuration may be made to enable recording on a recording medium P in the form of a single sheet. In cases configured to enable recording on a single-sheet recording medium P, what is referred to as a paper (feed) tray, a paper (feed) cassette or the like may be employed, for example, as the feeder 14 for the recording medium P. As a collection section of the recording medium P, what are referred to as an output collector, paper (output) tray, paper (output) cassette or the like may, for example, be employed as the collection section instead of the winding section 15.

The recording apparatus 1 of the present embodiment is provided with a drive roller 5 between the platen 2 and the platen 3, and a fan 7 serving as an air blower positioned (above) facing toward the drive roller 5. The fan 7 is capable of blowing air in a direction D toward the drive roller 5. Accordingly, the recording medium P is pressed against the drive roller 5 by the air pressure from the fan 7. A transport section 9 is configured by the thus configured drive roller 5 and the fan 7.

In other words, the transport section 9 includes: the drive roller 5 that is provided so as to be contactable with a first face 17 of the recording medium P (the back face with respect to the recording face), and that imparts feeding force to the first face 17; and the fan 7 that is provided in a position facing toward the drive roller 5, and that is capable of blowing air onto a second face 16 (the recording face) of the recording medium P. The recording medium P is pressed against the drive roller 5 by the fan 7, and transported in the transport direction A.

The drive roller 5 rotates in the rotation direction C in order to transport the recording medium P in the transport direction A.

In the recording apparatus 1 of the present embodiment, the transport section 9 obviously corresponds to the transport section of the invention, and the feeder 14 and the winding section 15 also contribute to transporting the recording medium P, and therefore also correspond to the transport section of the invention.

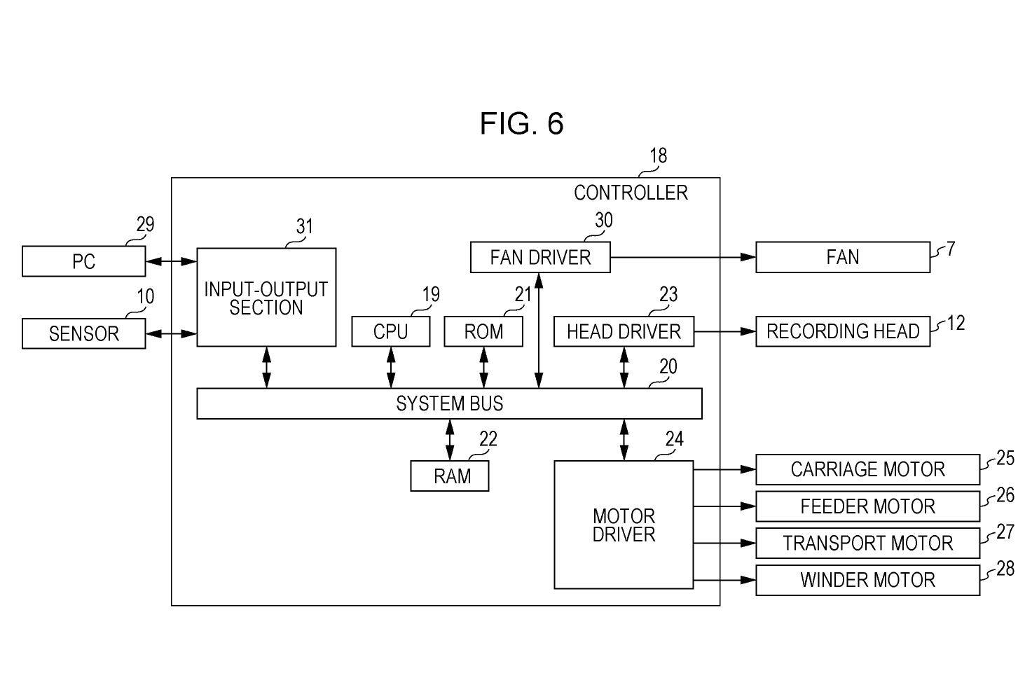

The fan 7 is divided along a cross direction B that intersects with the transport direction A, as illustrated by fan 7a to fan 7d in FIG. 2, which are capable of being separately driven under control from a controller 18 (see FIG. 6). In other words, the fan 7 is capable of adjusting the pressing force along the cross direction B.

Adopting such a configuration enables the controller 18 to adjust the pressing force along the cross direction B, and to adjust the transport speed of the recording medium P along the cross direction B. More specifically, it is, for example, possible to release the recording medium P at the fan 7a side by decreasing the air volume of the fan 7a, and to make the transport speed at the fan 7a side slower than the transport speed at the fan 7d side. The recording apparatus 1 of the present embodiment suppresses by such a simple configuration problems arising due to skewed transport of the recording medium P.

In the transport section 9 of the present embodiment, the recording medium P is transported without nipping the recording medium P with a roller pair, and therefore transport problems such as leaving roller marks as the recording medium P is being transported are suppressed. It is, in particular, a configuration capable of preventing marks of a following roller from being imparted to the recording face side of the recording medium P.

However, a transport section 9 may be employed that is configured with a following roller provided in place of the fan 7, and in which the recording medium P is transported by nipping the recording medium P between the drive roller 5 and the following roller.

The present embodiment employs the recording medium P wound in the form of a roll such that the recording face is on the outside, and therefore the rotation shaft of the feeder 14 is rotated in the rotation direction C in order to feed out the recording medium P from the feeder 14. In cases in which a recording medium P in the form of a roll wound with the recording face on the inside is employed, the rotation shaft of the feeder 14 may be rotated in the opposite direction to the rotation direction C to feed out the recording medium P.

Similarly, the winding section 15 of the present embodiment winds the recording medium P such that the recording face is on the outside, and therefore the rotation shaft of the winding section 15 is rotated in the rotation direction C. However, in cases in which winding is performed such that the recording face is on the inside, the rotation shaft of the winding section 15 may be rotated in the opposite direction to the rotation direction C to wind the recording medium P.

The recording apparatus 1 of the present embodiment includes a recording head 12 serving as a recording section on the side facing toward the platen 3. In the recording apparatus 1, ink is ejected onto the recording medium P from an ink ejection face F of the recording head 12 while the recording head 12 is caused to reciprocate by a carriage 11 along the cross direction B, so as to form the desired image.

The recording apparatus 1 of the present embodiment includes the recording head 12 that records while reciprocating, however a recording apparatus may be employed including what is referred to as a line head with plural nozzles that eject ink provided along the cross direction B.

Reference here to “line head” means a recording head with a nozzle region that is formed along the cross direction B intersecting with the transport direction A of the recording medium P and that is provided so as to be capable of covering the entire cross direction B of the recording medium P. Such a recording head is employed in a recording apparatus that forms an image by relative movement of the recording head and the recording medium. The nozzle region in the cross direction B of a line head does not necessarily need to be capable of covering the entire cross direction B for all the recording media P compatible with the recording apparatus.

In the drawings the direction X and the direction Y are orthogonal to each other and run along the horizontal direction, and the direction Z is the vertical direction. In the recording apparatus 1 of the present embodiment, the transport direction A of the recording medium P above the platen 3 corresponds to the direction Y, and the cross direction B corresponds to the direction X.

In the recording apparatus 1 of the present embodiment, the transport section 9 is provided at the upstream side of the recording head 12 in the transport direction A. However, the transport section 9 may be provided on both sides of the recording head 12 in the transport direction A. In a configuration in which transport sections 9 are provided on both sides, the recording medium P can be pressed against the drive rollers 5 on both sides, thereby enabling transport problems such as jams to be effectively suppressed.

As illustrated in FIG. 1, the fan 7 of the transport section 9 blows air in the direction D that is a direction away from the recording head 12. More specifically, the fan 7 blows air in the direction D toward the upstream side in the transport direction A. Accordingly, air blown from the fan 7 that affects the state of the ink ejected from the recording head 12 is suppressed, and occurrence of landing position misalignment of the ink on the recording medium P is suppressed. Foreign objects adhered to the second face 16 of the recording medium P are removed by the blown air, thereby enabling the occurrence of recording defects to be suppressed.

The fan 7 of the present embodiment blows air so as to flow in the opposite direction to the direction where the recording head is situated. However, configuration may be made such that the air is blown so as to flow in a direction intersecting with the direction where the recording head is situated. In such cases, mist of ink ejected from the recording head 12 floating between the recording head 12 and the recording medium P and re-adhering to the recording head 12 is suppressed, thereby enabling stable ejection of ink from the recording head 12. However, the blowing direction of the fan 7 may be the direction toward the recording head 12. A configuration is also possible in which plural fans 7 are provided along a direction intersecting with the transport direction A, such that the direction of blowing of each fan is individually changeable according to the position of the carriage 11 moving along the direction B at the downstream side in the transport direction. For example, configuration may be made such that a fan positioned at the downstream side in the movement direction of the carriage 11 in the direction B blows air toward the downstream side so that air flows in the opposite direction to the direction toward the recording head 12.

Moreover, as illustrated in FIG. 2 and FIG. 3, a sensor 10 is provided at each end portion of the carriage 11 in the direction B as a gap detection section that detects the gap (PG) between the recording head 12 and the recording medium P. The sensors 10 also serve the role of a width detection section capable of detecting the width of the recording medium P in the cross direction B.

As illustrated in FIG. 5, the sensors 10 each include plural light emitting devices Ia, Ib, and Ic capable of radiating infrared light toward different positions Pa, Pb, and Pc on the recording medium P, and a single light receiving device R capable of receiving light reflected from the radiated infrared light by switching between the light emitting devices Ia, Ib, and Ic. The position Pa corresponds to the region illuminated by the light emitting device Ia, the position Pb corresponds to the region illuminated by the light emitting device Ib, and the position Pc corresponds to the region illuminated by the light emitting device Ic. It is possible to compute the PG by detecting the distance to the recording medium P from the light reception intensity of light reflected from the different positions Pa, Pb, and Pc.

As described above, the recording apparatus 1 of the present embodiment includes the transport section 9 that transports the recording medium P, the carriage 11 that includes the recording head 12 capable of ejecting ink onto the recording medium P, and that is capable of moving along the cross direction B, and the sensors 10 that are provided to the carriage 11 and detect the PG.

The sensors 10 each include the plural light emitting devices Ia, Ib, and Ic capable of radiating light toward different positions Pa, Pb, and Pc on the recording medium P, and the single light receiving device R capable of receiving reflected light that was radiated from the plural light emitting devices Ia, Ib, and Ic.

By detecting the PG in this manner, the recording apparatus 1 of the present embodiment detects the PG with high precision and performs ink ejection control according to the PG. Deterioration in the quality of recorded images due to change in the PG is accordingly suppressed.

FIG. 3 illustrates a state in which cockling of the recording medium P has occurred, and the PG varies along the cross direction B. FIG. 4 is a graph illustrating an example of measurements of the PG in the state illustrated in FIG. 3, and the respective detection results of any one of the light emitting devices Ia, Ib, and Ic may be illustrated in such a graph.

The graph illustrated in FIG. 4 can be generated separately for the light emitting devices Ia, Ib, and Ic in the recording apparatus 1 of the present embodiment. That is, it is possible to detect the PG in three different regions corresponding to displacement of the regions illuminated by the light emitting devices Ia, Ib, and Ic in the transport direction A (displacement of the positions Pa, Pb, and Pc in the transport direction A) by moving the carriage 11 one time along the cross direction B. The PG is accordingly detected with high precision.

In the recording apparatus 1 of the present embodiment, the PG (the height of the recording medium P) is actually measured at a specific sampling period for all the light emitting devices Ia, Ib, and Ic, as illustrated in FIG. 4.

The controller 18 computes interpolation values from the actual values measured at the sampling period. More specifically, the mid value between preceding and following actual measurement values is taken as the interpolation value for the mid time during measurement between the preceding and following actual measurement values. By adopting such a method, the recording apparatus 1 of the present embodiment thereby detects the PG with higher precision.

The recording apparatus 1 of the present embodiment is capable of detecting the PG at plural positions on the recording medium P at the different positions Pa, Pb, and Pc, and is therefore capable of detecting lifting up of the recording medium P from the platen 3, or wrinkles W or the like, from the positions where the small values of PG are detected, and the values of PG at those positions or the like.

In the recording apparatus 1 of the present embodiment there are three light emitting devices serving as the plural light emitting devices capable of radiating infrared light toward different positions on the recording medium P. However configuration may be made with two light emitting devices, or with four or more light emitting devices. For example, in cases in which there are three light emitting devices, light emitted by the light emitting device Ia is received by the light receiving device R, light emitted by the light emitting device Ic is received by the light receiving device R, and light emitted by the light emitting device Ib is received by the light receiving device R, and by repeating this pattern, lifting is detected by computing distance from the light reception intensity of reflected light. Moreover, in cases in which lifting is detected by repeatedly emitting light from the light emitting devices Ia and Ib that, out of the light emitting devices Ia, Ib, and Ic, are disposed furthermost to the upstream side and furthermost to the downstream side of the carriage 11, and detecting the light reception intensity of reflected light with the light receiving device R, light may be emitted from the light emitting device Ic at a timing between emitting light from the light emitting devices Ia and Ib. In such cases, by detecting lifting occurring from the upstream side or downstream side in the transport direction, it is possible to detect whether wrinkles W have occurred from such lifting. Lifting may also be detected by computing the distance from the light reception intensity of the reflected light by repeatedly performing, in sequence, emitting light with the light emitting device Ia and receiving light with the light receiving device R, emitting light with the light emitting device Ic and receiving light with the light receiving device R, and emitting light with the light emitting device Ib and receiving light with the light receiving device R. The light receiving device may also be configured capable of detecting specular reflected light, diffuse reflected light, or total reflected light.

In the recording apparatus 1 of the present embodiment, the light respectively radiated from the plural light emitting devices Ia, Ib, and Ic is infrared light with the same characteristics, such as having the same wavelength. However, configuration may be made such that the characteristics such as wavelengths of light radiated from the plural light emitting devices are different from each other.

As illustrated in FIG. 2, the sensors 10 of the present embodiment are provided as sensors 10a and 10b at the two ends of the carriage 11 in the cross direction B, in a configuration capable of detecting the PG at the different positions Pa, Pb, and Pc on the recording medium P. The PG can then be detected by the sensor 10 b when the carriage 11 is moving in the direction B1 of the cross direction B, and detected by the sensor 10a when the carriage 11 is moving in the direction B2 of the cross direction B.

In other words, it may be said that the sensors 10 of the present embodiment are provided downstream of the recording head 12 in the movement direction of the carriage 11 when recording.

Change in the PG is accordingly detected prior to ink being ejected from the recording head 12, and deterioration in quality of recorded images due to change in PG is effectively suppressed.

As illustrated in FIG. 2, the sensors 10 of the present embodiment are provided at positions in a row with the recording head 12 along the cross direction B.

Accordingly, the PG immediately before ink is ejected from the recording head 12 is detected, ejection control according to the PG is effectively performed, and deterioration in quality of recorded images is effectively suppressed.

An electrical configuration of the recording apparatus 1 according to the present embodiment is described.

FIG. 6 is a block diagram of the recording apparatus 1 of the present embodiment.

A CPU 19 is provided in the controller 18 to perform overall control of the recording apparatus 1. The CPU 19 is connected through a system bus 20 to ROM 21 that stores various control programs and the like to be executed by the CPU 19, and to RAM 22 capable of temporarily storing data.

The CPU 19 is also connected through the system bus 20 to a head driver 23 for driving the recording head 12.

The CPU 19 is also connected through the system bus 20 to a motor driver 24 for driving a carriage motor 25 for moving the carriage 11, a feeder motor 26 that is the drive source of the feeder 14, a transport motor 27 that is the drive source of the drive roller 5, and a winder motor 28 that is the drive source of the winding section 15.

The CPU 19 is also connected through the system bus 20 to a fan driver 30 for driving the fans 7.

The CPU 19 is also connected through the system bus 20 to an input-output section 31, and the input-output section 31 is connected to the sensors 10, and to a PC 29 that is an external device for inputting recording data and the like to the recording apparatus 1.

In such a configuration, the controller 18 of the present embodiment controls at least one of the ink ejection timing and the ink ejection speed from the recording head 12, based on the detection results detected by the sensors 10.

Ink ejection control is thereby performed by the controller 18 according to the PG, and deterioration in the quality of recorded images due to change in the PG is suppressed.

More specifically, the PG is measured with respect to the entire width of the recording medium P prior to recording by the sensors 10 at plural points along the entire width direction. The longest PG from among these points is then set as the reference PG. Measurement of the PG may be omitted in cases in which the thickness of the recording medium P is measured in advance. During recording, the amount of lifting of the recording medium P from the platen 3 is computed by the difference between the reference PG and the PG detected by the sensors 10. Control is performed such that at least one of the ink ejection timing and the ink ejection speed is delayed or slowed as the lifting and wrinkles W become larger (higher). Similar control is performed in cases in which interpolation values are employed.

The controller 18 of the present embodiment estimates the PG from the received light intensity of the reflected light detected by the sensors 10.

Thus by estimating the PG from the received light intensity and performing ink ejection control based on the estimated PG, the controller 18 suppresses deterioration in the quality of recorded images due to change in the PG.

### Second Embodiment

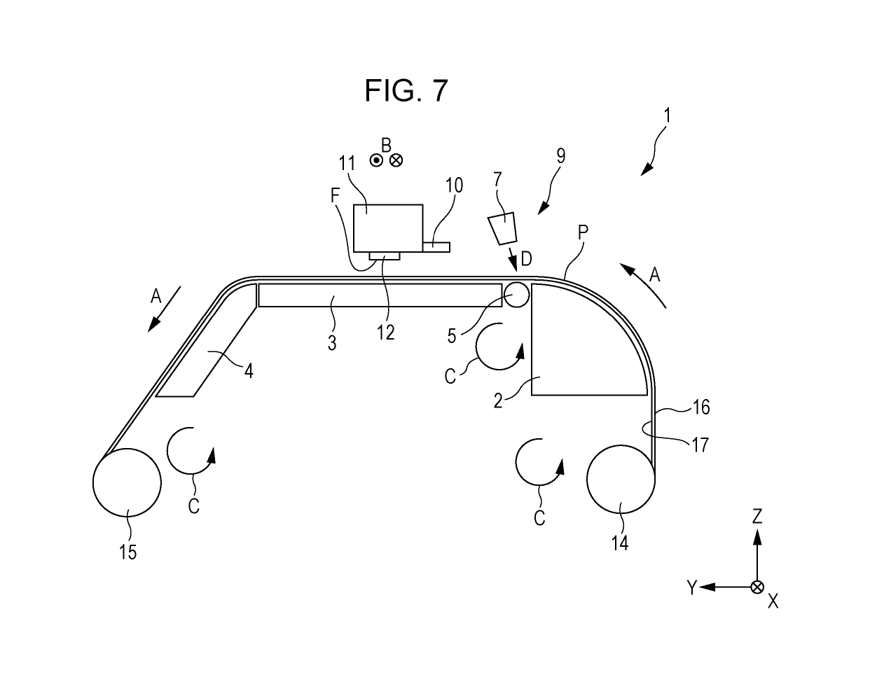

### FIG. 7

Detailed explanation now follows regarding a recording apparatus of a second embodiment, with reference to the appended drawings.

FIG. 7 is a schematic side view illustrating a recording apparatus 1 of the present embodiment. Configuration members common to those of the embodiment described above are appended with the same reference numerals, and detailed explanation thereof will be omitted.

The recording apparatus 1 of the present embodiment is configured similarly to the recording apparatus 1 of the first embodiment, apart from in the positions of the sensors 10 provided to the carriage 11.

As illustrated in FIG. 7, in the recording apparatus 1 of the present embodiment the sensors 10 are provided upstream of a recording head 12 in the transport direction A.

Thus when lifting or the like occurs in the recording medium P, the lifting or the like can be detected prior to the lifting or the like being transported to the recording position. That is, a configuration is adopted in which change in the PG can be detected prior to ejecting ink from the recording head 12, and deterioration in the quality of recorded images due to change in the PG can be effectively suppressed.

The controller 18 is capable of estimating change in the PG at the ink ejection region of the recording head 12 from the position where the PG has changed and the amount of change of the PG. Thus, in the configuration, deterioration in the quality of recorded images is effectively suppressed in particular in cases such as when lifting occurs from the upstream side in the transport direction A and wrinkles W are generated.

In the recording apparatus 1 of the present embodiment, the light respectively radiated from the plural light emitting devices Ia, Ib, and Ic is infrared light with the same characteristics, such as having the same wavelength. However, configuration may be made such that the wavelengths of light radiated from the plural light emitting devices are different from each other.

Setting the wavelengths of the light radiated from the plural light emitting devices to be different from each other enables deterioration in the precision of detecting PG due to the effects of color of the recording medium P to be suppressed.

### Third Embodiment

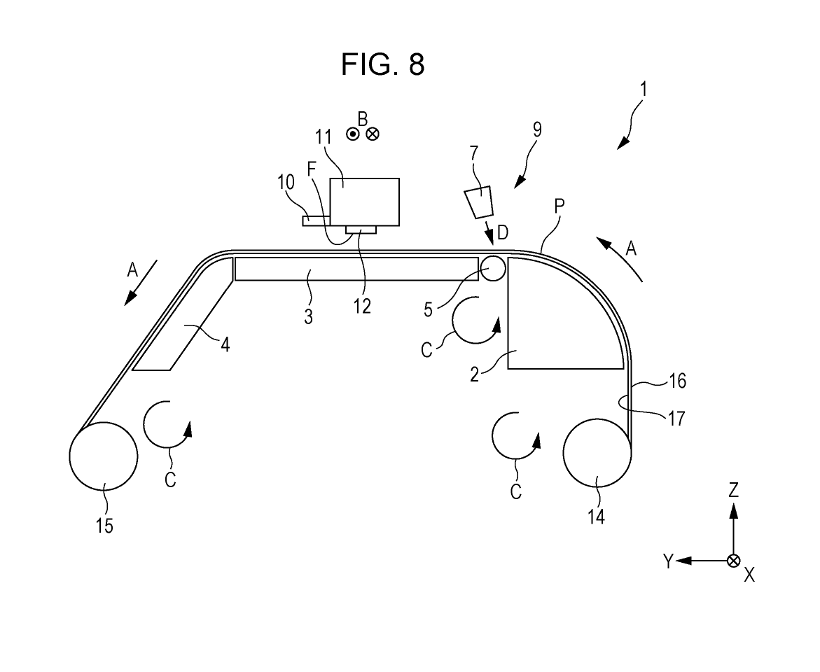

### FIG. 8

Detailed explanation now follows regarding a recording apparatus of a third embodiment, with reference to the appended drawings.

FIG. 8 is a schematic side view illustrating a recording apparatus 1 of the present embodiment. Configuration members common to those of the embodiments described above are appended with the same reference numerals, and detailed explanation thereof will be omitted.

The recording apparatus 1 of the present embodiment is configured similarly to the recording apparatuses 1 of the first embodiment and the second embodiment, except in the position of the sensors 10 provided to the carriage 11.

As illustrated in FIG. 8, in the recording apparatus 1 of the present embodiment, the sensors 10 are provided downstream of a recording head 12 in the transport direction A.

A controller 18 is capable of estimating the change in PG at the ink ejection region of the recording head 12 from the position where the PG changed and the amount of change in the PG. Thus, in the configuration, deterioration in the quality of recorded images is effectively suppressed in particular in cases such as when lifting occurs from the downstream side in the transport direction A and wrinkles W are generated.

In the recording apparatus 1 of the present embodiment, the light respectively radiated from the plural light emitting devices Ia, Ib, and Ic is infrared light with the same characteristics, such as having the same wavelength. However, configuration may be made such that the wavelengths of light radiated from the plural light emitting devices are different from each other.

Adopting a configuration in which the sensors 10 are provided downstream of the recording head 12 in the transport direction A, as in the recording apparatus 1 of the present embodiment, and setting the wavelengths of the light radiated from the plural light emitting devices to be different from each other enable deterioration in the detection precision due to the effects of the color of ink in addition to the color of the recording medium P to be suppressed.

In the recording apparatus 1 of the second embodiment the sensors 10 are provided upstream of the recording head 12 in the transport direction A, and in the recording apparatus 1 of the third embodiment the sensors 10 are provided downstream of the recording head 12 in the transport direction A. However, the sensors 10 may be provided both upstream of and downstream of the recording head 12 in the transport direction A. Adopting such a configuration enables deterioration in the quality of recorded images due to change in the PG to be effectively suppressed both in cases in which lifting occurs from the upstream side in the transport direction A and wrinkles W are generated, and in cases in which lifting occurs from the downstream side in the transport direction A and wrinkles W are generated.

The invention is not limited to the above embodiments, and various modifications are possible within a scope of the invention as recited in the scope of the patent claims, and obviously such modifications also fall within the scope of the invention.

Details regarding the invention have been given above based on specific embodiments. Explanation next follows once again to summarize the invention.

The recording apparatus 1 of a first aspect of the invention includes the transport section 9 that transports the recording medium P, the movement section 11 that includes the recording head 12 capable of ejecting ink onto the recording medium P, and that is capable of moving along the cross direction B intersecting with the transport direction A of the recording medium P, and the gap detection section 10 that is provided to the movement section 11 and detects the gap between the recording head 12 and the recording medium P, in which the gap detection section 10 includes the plural light emitting devices Ia, Ib, and Ic capable of radiating light toward different positions Pa, Pb, and Pc on the recording medium P, and the light receiving device R capable of receiving reflected light that was radiated from the plural light emitting devices Ia, Ib, and Ic.

According to the first aspect, the gap detection section 10 includes the plural light emitting devices Ia, Ib, and Ic capable of illuminating different positions Pa, Pb, and Pc on the recording medium P, and the single light receiving device R capable of receiving reflected light that was radiated from the plural light emitting devices Ia, Ib, and Ic. Detecting the gap (PG) in this manner enables the gap to be detected with high precision, and enables ink ejection control to be performed in accordance with the gap. This thereby enables deterioration in the quality of recorded images due to change in the gap to be suppressed.

The recording apparatus 1 of a second aspect of the invention is the recording apparatus 1 of the first aspect, including the controller 18 that controls at least one of the ink ejection timing and the ink ejection speed from the recording head 12 based on a detection result detected by the gap detection section 10.

According to the second aspect, the recording apparatus 1 includes the controller 18 that controls at least one of the ink ejection timing and the ink ejection speed from the recording head 12 based on the detection results detected by the gap detection section 10. This thereby enables ink ejection control to be performed by the controller 18 in accordance with the gap, and enables deterioration in the quality of recorded images due to change in the gap to be suppressed.

The recording apparatus 1 of a third aspect of the invention is the recording apparatus 1 of the second aspect, in which the controller 18 estimates the gap from received light intensity of the reflected light detected by the gap detection section 10.

According to the third aspect, the controller 18 estimates the gap from the received light intensity of the reflected light detected by the gap detection section 10. This thereby enables deterioration in the quality of recorded images due to change in the gap to be suppressed by the controller 18 estimating the gap from the received light intensity and performing ink ejection control according to the estimated gap.

The recording apparatus 1 of a fourth aspect of the invention is the recording apparatus 1 of any one of the first to the third aspects, in which the gap detection section 10 is provided upstream of the recording head 12 in the transport direction A.

According to the fourth aspect, the gap detection section 10 is provided upstream of the recording head 12 in the transport direction A. This thereby enables change in the gap to be detected prior to ink being ejected from the recording head 12, enabling deterioration in the quality of recorded images due to change in the gap to be effectively suppressed.

The recording apparatus 1 of a fifth aspect of the invention is the recording apparatus 1 of any one of the first to the fourth aspects, in which the gap detection section 10 is provided upstream of the recording head 12 in the movement direction of the movement section 11 during recording.

According to the fifth aspect, the gap detection section 10 is provided upstream of the recording head 12 in the movement direction of the movement section 11 in the cross direction B during recording. This thereby enables change in the gap to be detected prior to ink being ejected from the recording head 12, and enables deterioration in the quality of recorded images due to change in the gap to be effectively suppressed.

The recording apparatus 1 of a sixth aspect of the invention is the recording apparatus 1 of the fifth aspect, in which the gap detection section 10 is provided at a position in a row with the recording head 12 along the cross direction B.

According to the sixth aspect, the gap detection section 10 is provided at a position in a row with the recording head 12 along the cross direction B. This thereby enables the gap to be detected immediately before ejecting ink from the recording head 12, enables effective ejection control according to the gap, and enables deterioration in the quality of recorded images to be effectively suppressed.

The recording apparatus 1 of a seventh aspect of the invention is the recording apparatus 1 of any one of the first to the sixth aspects, in which the wavelengths of the light radiated from the plural light emitting devices Ia, Ib, and Ic are different from each other.

According to the seventh aspect, the wavelengths of the light radiated from the plural light emitting devices Ia, Ib, and Ic are different from each other. It is accordingly possible to suppress deterioration in the detection precision due to the effects of the color of the recording medium P in cases in which, for example, the gap detection section 10 is provided upstream in the transport direction A. Moreover, in cases in which, for example, the gap detection section 10 is provided downstream in the transport direction A, it is possible to suppress deterioration in the detection precision due to the effects of the color of the ink in addition to the color of the recording medium P.

The entire disclosure of Japanese Patent Application No. 2014-085311, filed Apr. 17, 2014 is expressly incorporated by reference herein.

What is claimed is:

1. A recording apparatus comprising:
a transport section that transports a recording medium;
a movement section that includes a recording head capable of ejecting ink onto the recording medium, and that is capable of moving along a cross direction intersecting with a transport direction of the recording medium; and
a gap detection section that is provided to the movement section and detects a gap between the recording head and the recording medium, wherein
the gap detection section includes a plurality of light emitting devices capable of radiating light toward different positions on the recording medium, and a light receiving device capable of receiving reflected light that was radiated from the plurality of light emitting devices.

2. The recording apparatus of claim 1, further comprising:
a controller that controls at least one of ink ejection timing and ink ejection speed from the recording head based on a detection result detected by the gap detection section.

3. The recording apparatus of claim 2, wherein
the controller estimates the gap from received light intensity of the reflected light detected by the gap detection section.

4. The recording apparatus of claim 1, wherein
the gap detection section is provided upstream of the recording head in the transport direction.

5. The recording apparatus of claim 1, wherein
the gap detection section is provided downstream of the recording head in a movement direction of the movement section during recording.

6. The recording apparatus of claim 5, wherein
the gap detection section is provided at a position in a row with the recording head along the cross direction.

7. The recording apparatus of claim 1, wherein
wavelengths of light radiated from the plurality of light emitting devices are different from each other.
